(19) United States
(12) Patent Application Publication
(10) Pub. No.: US 2015/0358655 A1
(43) Pub. Date: Dec. 10, 2015

(54) ANALYZING INCOMING DIGITAL SIGNAL AT SET-TOP-BOX (STB) TO PROVIDE VALUE ADDED FEATURES FOR VIEWERS

(71) Applicant: HCL Technologies Ltd., Noida (IN)

(72) Inventor: Aashish Kaushik, Noida (IN)

(21) Appl. No.: 14/722,915

(22) Filed: May 27, 2015

(30) Foreign Application Priority Data
Jun. 4, 2014 (IN) 1493/DEL/2014

(51) Int. Cl. H04N 21/25; H04N 21/258

(52) U.S. Cl. CPC H04N 21/251; H04N 21/25891

(57) ABSTRACT

Disclosed herein are a system and a method for performing real time content analysis at a Set-Top-Box (STB) so as to identify contents/programs that match preferences set by the user. The system provides option for the user to provide inputs required for content analyzes in any suitable form such as audio/video/image/text, through any suitable internal/external input means. The user can also configure at least one user preference as active configuration based on which the system can perform the content analysis. The system analyzes contents as and when they are received at the STB to identify a match. If a match is detected, the system triggers any alert of a pre-configured type to notify the user of the content alert.

### CROSS-REFERENCE TO RELATED APPLICATIONS

This application claims priority to Indian application no. 1493/DEL/2014 filed on Jun. 4, 2014, the complete disclosure of which, in its entirety, is herein incorporated by reference.

### TECHNICAL FIELD

The embodiments herein relate to television services and, more particularly, to a mechanism for backend content analysis at set top box for suggesting contents that match user's preferences.

### BACKGROUND

In the era of digitalization, television systems also are getting digitalized. The big antennas and cable TV systems are slowly becoming part of history, as Set-Top-Boxes (STB) have started replacing them as part of the digitalization process. The STB provides means for the users to watch digital content. Television has always been favorite time pass for most of the people. As a result of this popularity, a lot of broadcasters have launched a lot many channels which fall into different categories. For a user, it is obviously difficult to keep track of all channels, and programs being telecasted in all these channels. Further, when

Like any other product, the STB also undergoes constant modifications to improve user experience. So, one such attempt obviously is to help users track certain program (s) they love to watch. Most of the STBs available in market allow the user to set reminders and the STB generates alerts based on the reminders set by the user. One disadvantage of this method is that it is dependent on the user intervention, as the user needs to find out the program, channel, and time information, and set reminders.

Some of the systems available in market facilitate automated content analysis and alert triggering. However, the available mechanisms static way of content processing i.e. content analysis is performed only based on a part of actual content, which is pre-fetched from content providers. This may result in the user getting inaccurate results and not getting results in real time.

### SUMMARY

In view of the foregoing, an embodiment herein provides a method for suggesting contents that match user's preference in a Set Top Box (STB). Initially broadcast content from at least one broadcasting station and user preference information pertaining to a preferred content type are received. The received broadcast content is analyzed in real time to identify at least one content that matches the received user preference information, and at least one pre-configured alert is triggered upon identifying at least one content that matches the received user preference information.

Embodiments further disclose a system for suggesting contents that match user's preference in a Set Top Box (STB). The system is configured to receive broadcast content from at least one broadcasting station, and user preference information pertaining to a preferred content type as inputs. The system analyzes in real time the received broadcast content using the real time content analysis and content recommendation engine and triggers at least one pre-configured alert upon identifying at least one content that matches the received user preference information.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of backend content analysis system, as disclosed in embodiments herein;

FIG. 2 illustrates a block diagram which depicts various components of the backend content analysis system, as disclosed in embodiments herein; and

FIG. 3 is a flow diagram which depicts various steps involved in the process of identifying contents that match user's preference and triggering alerts, using the backend content analysis system, as disclosed in embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

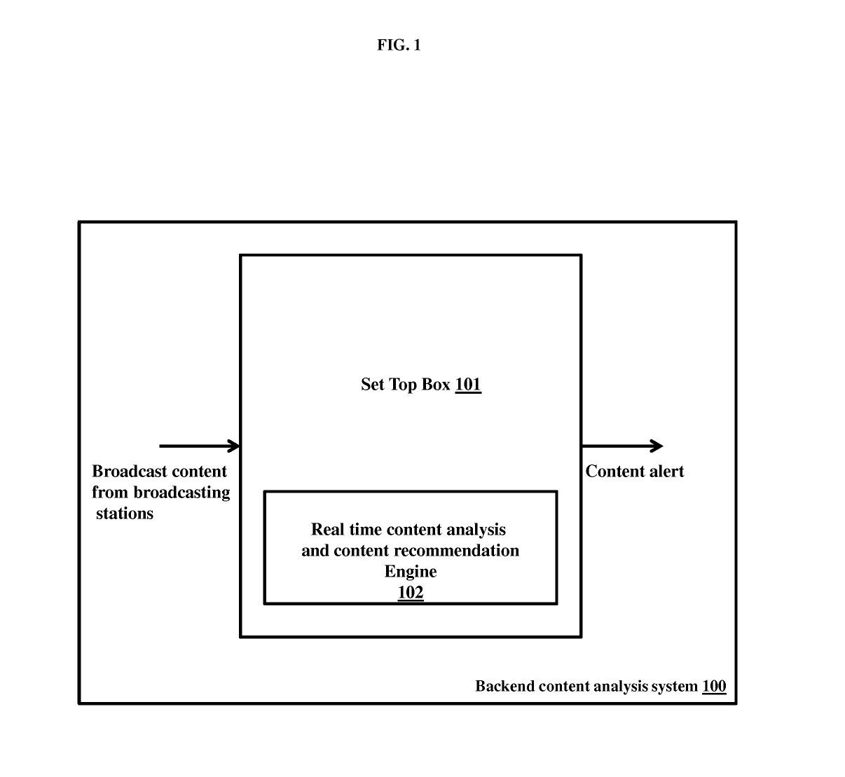

The embodiments herein disclose a mechanism for triggering content alerts using STB by identifying programs that match a specified user preference. Referring now to the drawings, and more particularly to FIGS. 1 through 3, where similar reference characters denote corresponding features consistently throughout the figures, there are shown embodiments.

FIG. 1 illustrates a block diagram of backend content analysis system, as disclosed in embodiments herein. The backend content analysis system comprises of a Set-Top-Box (STB) 101, which further comprises of a real time content analysis and content recommendation engine 102. The STB 101 receives digital broadcast contents from broadcasting stations. User of the STB 101 can specify content preferences by providing an input to the real time content analysis and content recommendation engine 102, using a suitable user interface provided to the user. In various embodiments, the input may be in an image, video, text, or audio format. The user may be provided option to select inputs required for content analysis, directly from contents being telecasted in any channel, while the user is watching any specific program. For example, if the user is watching a movie sequence, and intends to watch same or related contents when being telecasted by any channel at a later point of time, he/she may capture a screenshot which can be used as an image input, or record the content which can be used as a video input, or record audio which can be used as an audio input. The user may also provide audio/video/image/text inputs by plugging in an external storage device to the STB 101, or by using suitable options provided in the remote control, or the STB 101 itself. The real time content analysis and content recommendation engine 102 collects the received broadcast information in real time, and performs content analysis to identify content (s) that matches the pre-configured user preference information.

The content analysis process involves the real time content analysis and content recommendation engine 102 comparing in real time, broadcasting contents received at the STB 101 with the pre-configured inputs i.e. user preferences. The real time content analysis and content recommendation engine 102 may use any suitable audio/video/image/text processing means to do the content analysis, which may be selected based on the type of inputs received from the user.

Further, upon identifying any content that matches the set user preference data, the real time content analysis and content recommendation engine 102 triggers a pre-configured action. In a preferred embodiment, the action could be alerting the user of the possible content match. In another embodiment, the real time content analysis and content recommendation engine 102 may automatically tune the channel which telecasts the content/program which matches the users' preference. In certain cases where STB would have capabilities to receive and process/analyze content from multiple channels simultaneously, the real time content analysis and content recommendation engine 102 may identify that more than one channel is telecasting same or different contents that match the pre-configured user preference. In that case, the real time content analysis and content recommendation engine 102 may display all results in a suitable format and the user can make manual selection according channel/program preference.

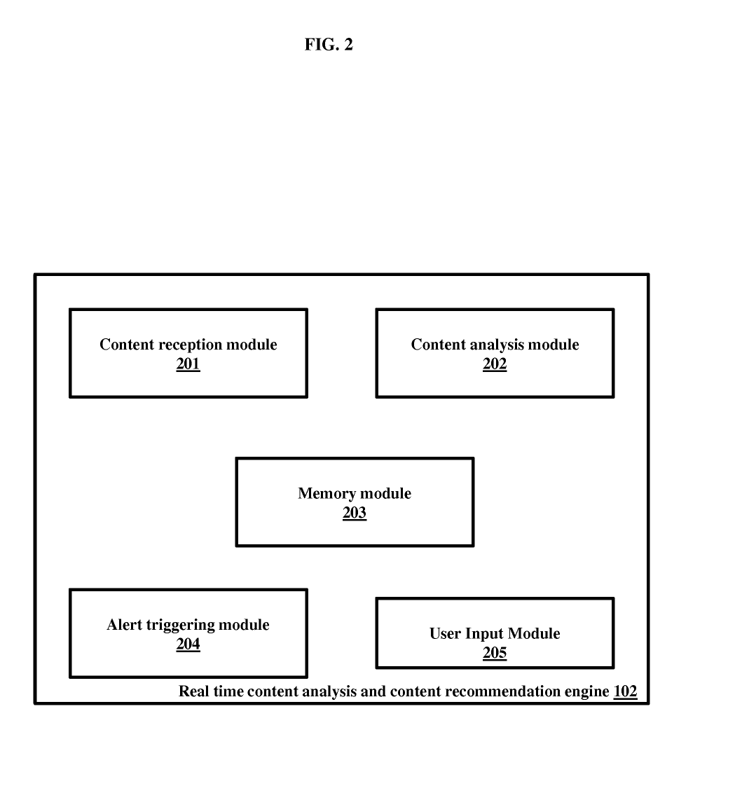

FIG. 2 illustrates a block diagram which depicts various components of the backend content analysis system, as disclosed in embodiments herein. The real time content analysis and content recommendation engine 102 comprises of a content reception module 201, a content analysis module 202, a memory module 203, an alert triggering module 204, and a user input module 205. The content reception module 201 possesses suitable interface to receive broadcast data received at the STB 101. The user input module 205 provides suitable options for the user to provide user preference data to the real time content analysis and content recommendation engine 102. The user preference data collected using the user input module 205 is then stored in the memory module 203, in a proper format. In an embodiment, the user preference may be defined in terms of only one parameter or a particular type of input file. In another embodiment, the preferences may be defined based on combination of a plurality of inputs/parameters, by defining a proper relation between the parameters; stored in a suitable data structure. Consider the example below which depicts how multiple parameters can be used to define user preferences.

TABLE 1

| | | Text | | Image | |
|---|---|---|---|---|---|
| Channel | | processing | | processing | |
| Number | Text | enabled | Image file | enabled | Action |
| 205 | XYZ | F | <path to | T | 1 |
| | | | image> | | |

In Table. 1, input in the channel number column is 205. Input text is “XYZ”; however, the value “F” in the third column indicates that the text processing has been disabled. The same may be enabled by setting the value as “T”. Image processing is enabled by setting value as “T”, and path to image is defined in column 4. The last column “Action” is to define actions to be triggered upon finding a content match. The action could be alerting the user, or automatically tuning to corresponding channel.

Similar way, user preferences may be defined based on any suitable combination of selected parameters. For each parameter, values may be defined which indicate activated/de-activated status of the parameter. For example, flag values may be used to indicate whether a parameter is to be used for content analysis or not. In an embodiment, multiple user preferences may be stored as different “configurations” such that the user may choose one or more of them to be “active” at a particular time. The number of configurations the user can configure with the real time content analysis and content recommendation engine 102 may depend on capabilities of internal circuitry. For example, the system may require multiple channel processing capabilities to support more than one active configuration.

The memory module 203 may also store summary data generated by the content analysis module 202. In an embodiment, the summary data is generated by the content analysis module 202 by capturing certain frames from the content which is found to match the user's preference. The summary data may be generated by capturing frames for a pre-defined time interval from the identified content, as pre-configured by the user.

The alert triggering module 204 triggers alerts of pre-configured type, upon receiving commands from the content analysis module 202. The alert may be in any suitable format such as audio/video/text message and so on. For example, a pop-up window may display a message to the user that a matching content has been found, along with supporting information such as, but not limited to channel number, and time of start of the program. In another example, if the system supports any suitable technology such as Picture In Picture (PIP), a video captured from the channel which is found to be telecasting the content that matches user preference can be displayed to the user, over the content being viewed by the user at that particular time. In addition to triggering alerts, the alert triggering module 204 may also be used to trigger any other action which is pre-configured by the user. For example, the alert triggering module 204 may be configured to automatically tune to the channel which telecasts the content that is found to match the user's preference, using proper supporting hardware support. For example dual tuner STBs and single tuner STBs have different hardware specifications, hence may support different applications of the alert triggering module 204. As another example the STB 101 may have a feature of doing Pre-Post recording of the content on the alert being triggered. This would enable user to watch an entire program based on time duration of Pre-Post recording configured by him.

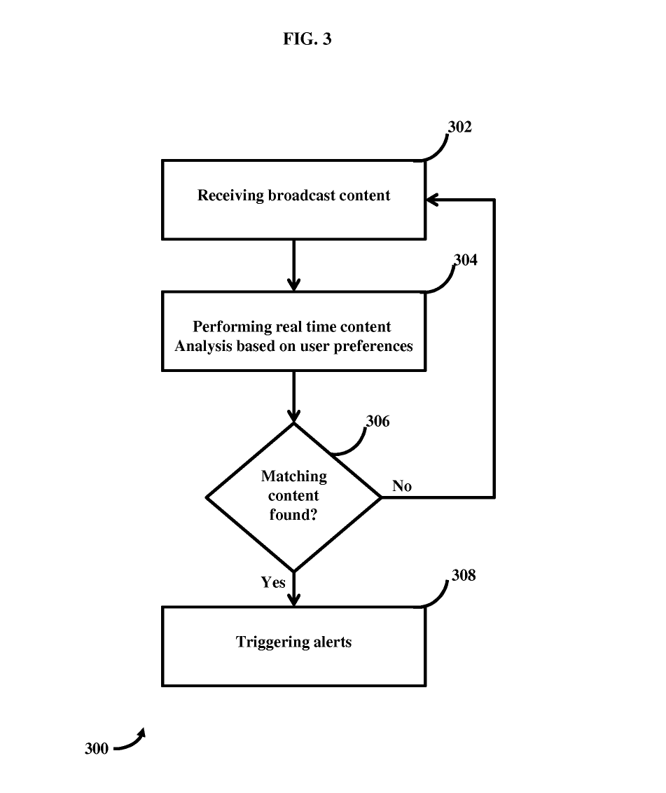

FIG. 3 is a flow diagram which depicts various steps involved in the process of identifying contents that match user's preference and triggering alerts, using the backend content analysis system, as disclosed in embodiments herein. The STB 101 receives (302) digital broadcast contents from broadcasting stations. The real time content analysis and content recommendation engine 102 then performs (304) real time analysis of the received content. During the real time content analysis, the content analysis module 202 in the real time content analysis and content recommendation engine 102 compares the received content with user preferences received as inputs from the user. The real time content analysis and content recommendation engine 102 may use any suitable audio/video/text processing schema/techniques to perform the content analysis, based on type of input and configuration (s) provided by the user. The real time content analysis and content recommendation engine 102 analyzes whole content received at the STB 101 that means all the frames and not just selected frames.

If a matching content is found (306), then the real time content recommendation engine 102 triggers (308) an alert of a specific type, as pre-configured by the user. In an embodiment, the alert may be in any of video/audio/text format, providing the user information such as but not limited to, type of content detected, channel (s) which telecasts the content, and time. The user may also be provided with a suitable user interface to tune to the suggested channel to watch the content identified by the real time content analysis and content recommendation engine 102. In a preferred embodiment, the user may configure the alert triggering module 204 to automatically tune the STB 101 to display the identified content to the user. The various actions in method 300 may be performed in the order presented, in a different order or simultaneously. Further, in some embodiments, some actions listed in FIG. 3 may be omitted.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiments disclosed herein specify a system for real time content analysis and alert triggering, in a STB. The mechanism allows real time content analysis to identify contents/programs that match preferences set by a user, and generating alerts to notify the user about possible content match, providing a system thereof. Therefore, it is understood that the scope of protection is extended to such a system and by extension, to a computer readable means having a message therein, said computer readable means containing a program code for implementation of one or more steps of the method, when the program runs on a server or mobile device or any suitable programmable device. The method is implemented in a preferred embodiment using the system together with a software program written in, for ex. Very high speed integrated circuit Hardware Description Language (VHDL), another programming language, or implemented by one or more VHDL or several software modules being executed on at least one hardware device. The hardware device can be any kind of device which can be programmed including, for ex. any kind of a computer like a server or a personal computer, or the like, or any combination thereof, for ex. one processor and two FPGAs. The device may also include means which could be for ex. hardware means like an ASIC or a combination of hardware and software means, an ASIC and an FPGA, or at least one microprocessor and at least one memory with software modules located therein. Thus, the means are at least one hardware means or at least one hardware-cum-software means. The method embodiments described herein could be implemented in pure hardware or partly in hardware and partly in software. Alternatively, the embodiment may be implemented on different hardware devices, for ex. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for suggesting contents that match users preference in a Set Top Box (STB), said method comprises of:
receiving broadcast content from at least one broadcasting station;
receiving user preference information pertaining to a preferred content type;
analyzing in real time said broadcast content received from said at least one broadcasting station; and
triggering at least one pre-configured alert upon identifying at least one content that matches said received user preference information.

2. The method as claimed in claim 1, wherein analyzing in real time said received broadcast content further comprises of:
comparing in real time said received broadcast content with said received user preference information; and
identifying said at least one content that matches said received user preference information.

3. The method as claimed in claim 2, wherein at least one of an audio, video, image, or text processing algorithm is used for comparing in real time said received broadcast content with said received user preference information.

4. The method as claimed in claim 1, wherein said user preference information may comprise of at least one of an audio, video, text, or image.

5. The method as claimed in claim 4, wherein said user preference information is stored as a configuration, wherein said configuration comprises of information related to at least one parameter based on which said at least one content that matches said user preference information is identified.

6. A system for suggesting contents that match users preference in a Set Top Box (STB), said system configured for:
receiving broadcast content from at least one broadcasting station, using said STB;
receiving user preference information pertaining to a preferred content type, using a real time content analysis and content recommendation engine;
analyzing in real time said broadcast content received from said at least one broadcasting station, using said real time content analysis and content recommendation engine; and
triggering at least one pre-configured alert upon identifying at least one content that matches said received user preference information, using said real time content analysis and content recommendation engine.

7. The system as claimed in claim 6, wherein said real time content analysis and content recommendation engine is further configured to analyze in real time said received broadcast content by:
comparing in real time said received broadcast content with said received user preference information, using a content analysis module; and
identifying said at least one content that matches said received user preference information, using said content analysis module.

8. The system as claimed in claim 7, wherein said content analysis module is further configured to use at least one of an audio, video, image, or text processing algorithm for comparing in real time said received broadcast content with said received user preference information.

9. The system as claimed in claim 6, wherein said real time content analysis and content recommendation engine is further configured to receive at least one of an audio, video, text, or image as said user preference information.

10. The system as claimed in claim 9, wherein said real time content analysis and content recommendation engine is further configured to store said user preference information as a configuration, wherein said configuration comprises of information related to at least one parameter based on which said at least one content that matches said user preference information is identified.
